(19) United States
(12) Patent Application Publication
(10) Pub. No.: US 2017/0096104 A1
(43) Pub. Date: Apr. 6, 2017

(54) POTENTIAL HAZARD INDICATING SYSTEM AND METHOD

(71) Applicant: FORD GLOBAL TECHNOLOGIES, LLC, Dearborn, MI (US)

(72) Inventors: Steven KELLY, London (GB); Liberty FEARNS, East Ham London (GB); Marcus HOGGARTH, Albans Hertfordshire (GB); Susan COOK, Brockley London (GB)

(73) Assignee: FORD GLOBAL TECHNOLOGIES, LLC, Dearborn, MI (US)

(21) Appl. No.: 15/263,874

(22) Filed: Sep. 13, 2016

(30) Foreign Application Priority Data
Oct. 2, 2015 (GB) 1517399.0

(51) Int. Cl. B60Q 9/00

(52) U.S. Cl. CPC B60Q 9/008

(57) ABSTRACT

A method of indicating potential hazards to a driver of a motor vehicle may include determining the presence of a potential hazard, determining a direction to the potential hazard relative to the driver of the motor vehicle, selecting one or more of a plurality of speakers provided in the motor vehicle and surrounding the driver, the one or more speakers being in substantially the same direction relative to the driver as the potential hazard, and emitting a warning sound from said one or more speakers.

### CROSS-REFERENCE TO RELATED APPLICATIONS

This application claims foreign priority benefits under 35 U.S.C. §119(a)-(d) to GB 1517399.0 filed Oct. 2, 2015, which is hereby incorporated by reference in its entirety.

### TECHNICAL FIELD

The present disclosure relates to a method and system for indicating potential hazards to a driver of a motor vehicle.

### BACKGROUND

A driver of a motor vehicle may be faced with multiple potential hazards at any particular time. Some potential hazards will be visible to the driver while others may not. Furthermore, multiple potential hazards may be visible to the driver at a particular time, but the driver may be unable to focus on all of the visible hazards, or to do so may impair the driver's ability to process the hazards and respond accordingly. The present disclosure therefore seeks to improve the driver's awareness of potential hazards and the ability to process potential hazards whether visible or not.

### SUMMARY

According to an aspect of the present disclosure, there is provided a method of indicating potential hazards to a driver of a motor vehicle, the method comprising determining the presence of a potential hazard, determining a direction to the potential hazard relative to the driver of the motor vehicle, selecting one or more of a plurality of speakers provided in the motor vehicle and surrounding the driver, the one or more speakers being in substantially the same direction relative to the driver as the potential hazard, and emitting a warning sound from the selected one or more speakers.

The method may further comprise tracking the potential hazard. The direction to the potential hazard may be updated, and the speakers from which sound is emitted may be adjusted in response to movement of the potential hazard.

The method may further comprise emitting the warning sound from a pair of neighboring speakers if the potential hazard direction is between the neighboring speakers. The warning sound may be emitted at a higher volume from a first speaker of the pair of neighboring speakers than a second speaker of the pair of neighboring speakers if the potential hazard direction is closer to the first speaker than the second speaker. For example, the method may further comprise fading in and fading out successive speakers as the direction to the potential hazard moves.

The method may further comprise amplifying a sound from the hazard to provide the warning sound. For example, if the hazard is an emergency response vehicle, such as a fire engine, police car or ambulance, the warning sound may comprise an amplification of a sound coming from a siren on the emergency response vehicle.

Additionally or alternatively, the method may further comprise emitting a predetermined warning sound for the potential hazard, e.g. for hazards that emit little or no sound, such as bicycles, pedestrians, bollards (traffic posts), etc. A predetermined warning sound may also be overlaid over hazards that do emit a sound, such as emergency response vehicles or any other vehicle. The predetermined warning sound may be associated with the particular hazard, for example the predetermined warning sound comprises one or more words associated with the hazard. In a particular example, the predetermined warning sound could comprise the words “bicycle” or “pedestrian” to warn the driver of a bicycle or pedestrian respectively.

The method may comprise attenuating other audible sounds within the vehicle, such as sounds from an audio system and/or a visual system of the vehicle, for example if a potential hazard is detected. Attenuation of these other sounds may help to heighten the driver's awareness of the warning sound.

The method may further comprise determining the distance of a potential hazard from the vehicle. The volume of the warning sound may be increased as the potential hazard gets closer to the vehicle. Likewise, the volume of the warning sound may be decreased as the potential hazard gets further from the vehicle.

The method may further comprise changing the frequency of the warning sound as the relative velocity between the potential hazard and the vehicle changes to simulate the Doppler effect.

The method may comprise using a hazard detection system on board the vehicle for determining the presence of a potential hazard. The hazard detection system may use sensors, such as all-weather radar, lasers, and/or camera sensors to detect a potential hazard. The method may further comprise communicating with another vehicle to determine the presence of a potential hazard, e.g. which may not yet be visible or detectable by the vehicle's own hazard detection system. The potential hazard may be the other vehicle or a potential hazard detected by the other vehicle. For example, an emergency response vehicle may broadcast its location and the vehicle may receive such a broadcast and determine the direction to the emergency response vehicle based on the data received.

Additionally or alternatively, the method may further comprise communicating with a server to determine the presence of the potential hazard. Other vehicles may provide the server with information about potential hazards.

According to a second aspect of the present disclosure there is provided a hazard indicating system for indicating hazards to a driver of a motor vehicle, wherein the system comprises one or more controllers configured to carry out any of the above-mentioned methods.

A vehicle may comprise the above-mentioned hazard indicating system.

To avoid unnecessary duplication of effort and repetition of text in the specification, certain features are described in relation to only one or several aspects or embodiments. However, it is to be understood that, where it is technically possible, features described in relation to any aspect or embodiment may also be used with any other aspect or embodiment.

For a better understanding of the claimed subject matter, and to show more clearly how it may be carried into effect, reference will now be made, by way of example, to the accompanying drawings, in which:

### BRIEF DESCRIPTION OF THE DRAWINGS

FIG. 1 is a flow diagram depicting a method according to an arrangement of the present disclosure;

FIGS. 2A and 2B are schematic top views depicting a system according to an arrangement of the present disclosure with FIG. 2A showing a vehicle and a potential hazard at a first relative position and FIG. 2B showing the vehicle and potential hazard at a second relative position; and

FIGS. 3A and 3B are schematic top views depicting the system according to the arrangement of the present disclosure with FIG. 3A showing the vehicle and a further hazard at a first relative position and FIG. 2B showing the vehicle and hazard at a second relative position.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

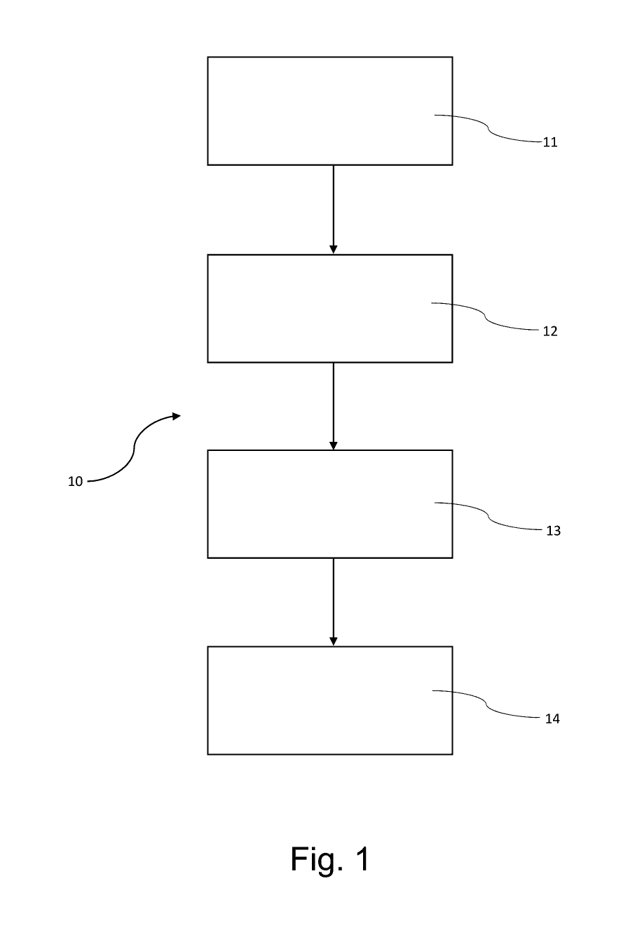

With reference to FIG. 1, the present disclosure relates to a method 10 for indicating potential hazards to a driver of a motor vehicle. The method comprises a first step 11 of determining the presence of a potential hazard. In a second step 12, a direction to the potential hazard relative to the driver of the motor vehicle is determined. The direction may extend from the driver's head. The direction may extend to a particular point on the potential hazard, e.g. a noise emitting point, such as a siren, or any other particular point. The direction may be in vector or polar coordinates or any other form. In a third step 13, one or more of a plurality of speakers provided in the motor vehicle and surrounding the driver may be selected. The selected one or more speakers are in substantially the same direction relative to the driver as the potential hazard. In a fourth step 14, a warning sound from the selected one or more speakers is emitted.

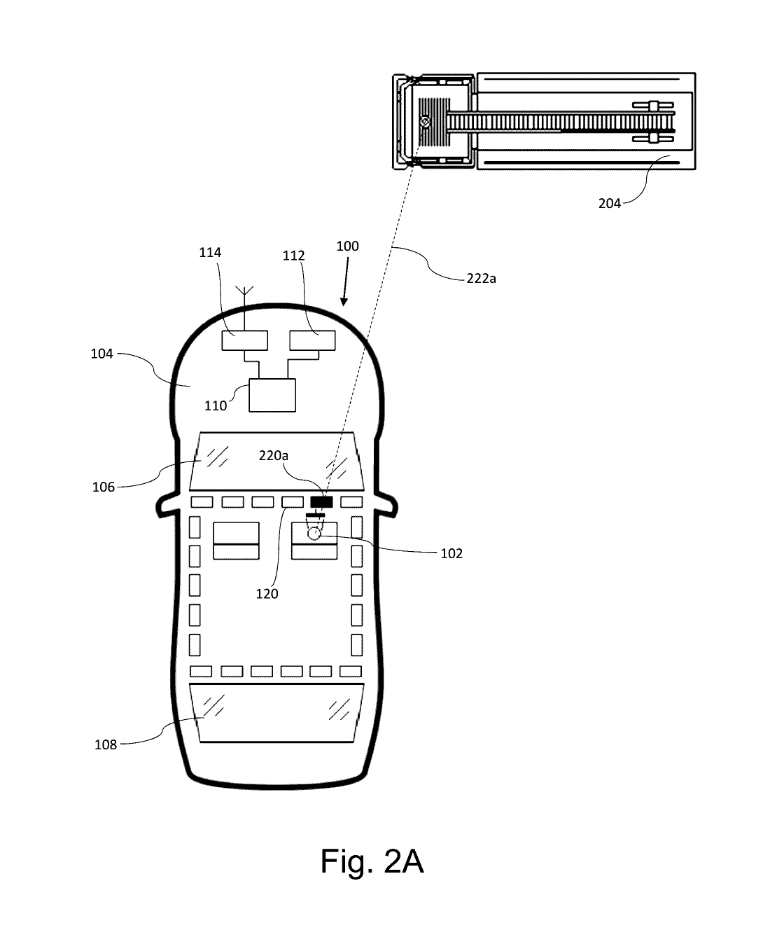

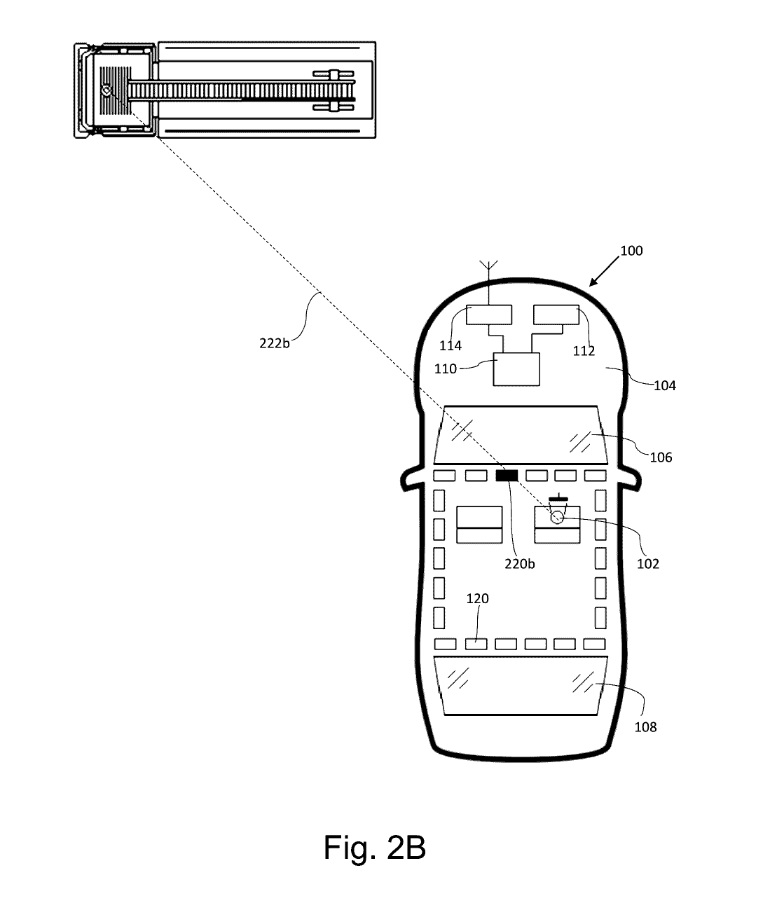

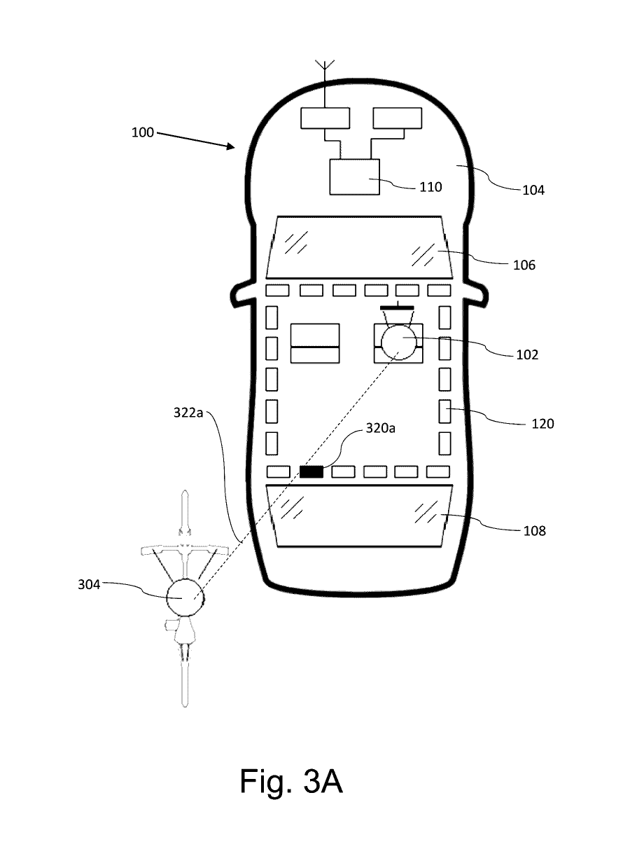

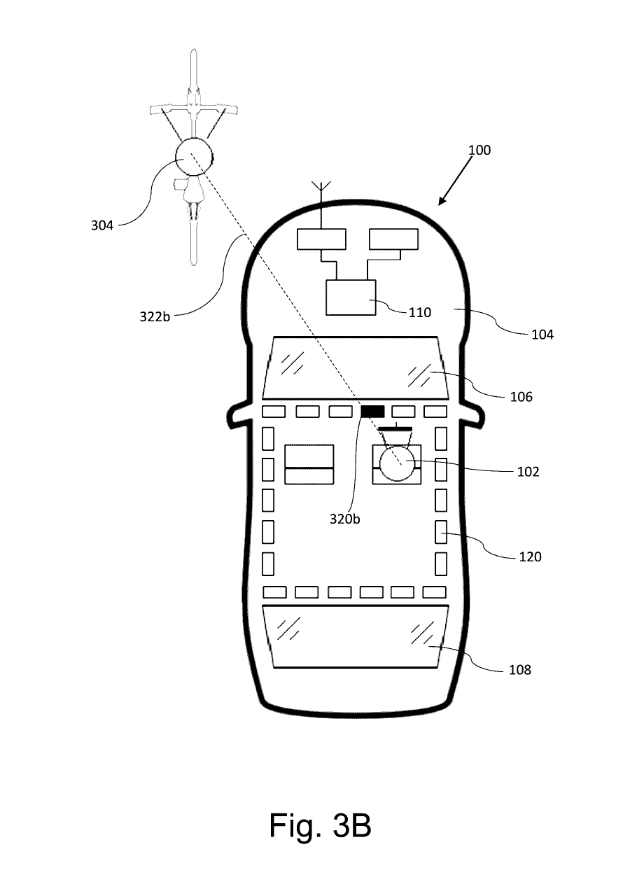

With reference to FIGS. 2 and 3, the present disclosure also relates to a system 100 for indicating potential hazards to a driver 102 of a vehicle 104, such as a motor vehicle. While the position of driver 102 is indicated on the right side of the vehicle in this embodiment, the driver position may also be on the left-side of the vehicle in other embodiments depending on the particular driving convention where the vehicle is intended to be operated. The system 100 may comprise one or more controllers 110 configured to carry out the above described method 10. In particular, the controllers 110 may determine the presence of a potential hazard and calculate a direction to the potential hazard relative to the driver 102. The controllers 110 may then select one or more of a plurality of speakers 120 that surround the driver 102, the selected one or more speakers being substantially in the same direction relative to the driver as the potential hazard. The one or more controllers 110 then send a signal such that a warning sound is emitted from the selected one or more speakers.

The plurality of speakers 120 substantially surrounds the driver 102 of the vehicle 104. The plurality of speakers 120 may be provided within the cabin of the vehicle 104. In particular, the plurality of speakers 120 may be disposed about a perimeter of the cabin. The speakers 120 may also surround passengers of the vehicle 104 in addition to the driver 102 and as a result may not be centered on the driver of the vehicle (although in alternative arrangements the speakers may be centered on the driver). By way of example, the plurality of speakers 120 may be provided in a roof of the vehicle 104, e.g. along an edge of the roof where the roof meets the front and rear windscreens 106, 108 and the doors of the vehicle 104. The plurality of speakers 120 may additionally or alternatively be provided in trim sections of the vehicle 104, for example in the dashboard, pillars and/or door trims of the vehicle 104. As depicted in FIGS. 2 and 3, the plurality of speakers 120 may be disposed in a quadrilateral arrangement, although it is equally envisaged that they may be arranged in any other shape, e.g. a circle.

The plurality of speakers 120 may be provided in sufficient number so that the driver 102 cannot necessarily discern from which of the speakers 120 the warning sound is being emitted from. For example, there may be at least eight speakers 120 distributed around the driver 102. The speakers 120 may or may not be equi-angularly distributed about the driver 102. In the case of the driver 102 not being at a center of the distributed speakers 120, e.g. as depicted in FIGS. 2 and 3, the spacing between speakers 120 closer to the driver 102 may be less than the spacing between speakers 120 further away from the driver 102. Such variance in speaker spacing may ensure that the speakers 120 are substantially equi-angularly distributed about the driver. The number of speakers 120 required may thus be reduced. Alternatively, the speakers 120 may be distributed with equal spacing.

The plurality of speakers 120 may form part of an audio sound system of the vehicle 104, although it will be appreciated that different or additional speakers may form part of such an audio sound system.

The system 100 may further comprise one or more sensors 112 configured to detect the presence of a potential hazard, such as an emergency response vehicle, any other vehicle which may be in danger of colliding with the vehicle 104, a pedestrian, a cyclist or any other potential hazard of which it is desirable for the driver 102 of the vehicle 104 to be aware. It will be appreciated that the driver may take evasive action to avoid such potential hazards or may simply monitor the potential hazard and take no action if not required.

The sensors 112 may comprise any sensor that is capable of detecting such hazards, for example a camera system, a radar system, a laser system, or any other system that is capable of detecting hazards around the vehicle 104. Such sensors 112 may already exist on the vehicle 104 for example as part of a collision avoidance system, parking system, or any other system. In the case of the sensors comprising cameras, the controller 110 may comprise an image processing module that is configured to process the data from the cameras and establish what type of hazards there may be around the vehicle and where such hazards are relative to the vehicle. The controller 110 and/or sensors 112 may be configured to determine in which direction the hazard is relative to the vehicle 104, in particular from the driver of the vehicle. Accordingly, a plurality of sensors 112 may be provided, e.g. distributed, around the vehicle. The controller 110 may be configured to determine the direction from the driver of the vehicle to the hazard using data from the sensors 112. For example, the sensors 112 may establish in which direction the hazard is relative to the sensor and the controller 110 may apply a correction to determine the direction to the hazard relative to the driver. Such corrections may be small in cases where the hazard is far away or approximately in line with both the sensor and the driver. However, such corrections may be more significant, e.g. in cases where the driver, sensor and hazard are not in line with one another.

In addition to, or alternatively from, the sensors 112, the system 100 may comprise one or more wireless receivers 114. The wireless receivers 114 may receive data from other vehicles or a central server about potential hazards in the vicinity of the vehicle 104. For example, another vehicle may broadcast data about a potential hazard that may not be visible to the current vehicle 104. The other vehicle may have sensed such a hazard and determined its location and broadcast such data to the current vehicle 104. Using such data the controller 110 may then determine the relative position of the hazard to the driver 102 of the current vehicle 104. The other vehicle may broadcast data relating to the nature of the hazard in addition to its location. The hazard may be the presence of the other vehicle itself or some other hazard that the other vehicle has detected. For example, an emergency response vehicle may broadcast data warning other vehicles in the vicinity about the presence of the emergency response vehicle. Such data may also include the current location of the emergency response vehicle and likely future location of the emergency response vehicle. Such data may be sent wirelessly from vehicle to vehicle or via a central server.

With reference to FIG. 2, an example scenario is depicted. In FIG. 2a, an emergency response vehicle 204 is in a first position relative to the vehicle 104. By virtue of one or more sensors 112 and/or the wireless receiver 114 the controller 110 has determined the presence of the emergency response vehicle 204, which may present a hazard to the current vehicle 104. With data from the sensors 112 and/or receiver 114, the controller 110 calculates the direction from the driver of the vehicle, e.g. from the driver's head, to the emergency response vehicle 204, e.g. a particular point on the emergency response vehicle 204, such as the siren. The controller 110 knows in which seat the driver 102 must be sitting and therefore the approximate location of the driver's head. The controller 110 then selects speakers 220a that are in line with the directional line 222a from the driver 102 to the emergency response vehicle 204. Had the directional line 222a from the driver to the emergency response vehicle 204 passed between two neighboring speakers 220a, the controller 110 may have selected the neighboring speakers 220a either side of the directional line 222a. The controller 110, which is operatively coupled to the speakers 120, then sends an instruction to emit a warning sound from the selected speakers 220a.

The system 100 tracks the potential hazard, e.g. emergency response vehicle 204, and if the potential hazard moves relative to the vehicle 104, e.g. as depicted in FIG. 2b, the controller 110 may select different speakers 220b that are in line with the directional line 222b to the hazard and the warning sound may then be emitted from these different speakers.

The warning sound may comprise the sound emitted by the potential hazard e.g. the siren of the emergency response vehicle 204, which may be amplified. Additionally or alternatively, the warning sound may comprise a predetermined sound, e.g. one that is associated with that particular potential hazard. For example, the warning sound could comprise textual data with words indicating the nature of the hazard. By way of example, the warning sound could comprise the words “fire engine”.

The driver's awareness of the hazard may be improved by hearing a warning sound coming from the same direction as the hazard. Therefore, from the audible information, the driver may be able to determine approximately in which direction the hazard is without necessarily having to avert his gaze. This may be particularly beneficial in cases where the hazard may not have otherwise been visible to the driver or where the driver's attention needs to be focused elsewhere at that particular time. It is also advantageous that the relative direction of the hazard is tracked and that the warning sound is emitted from the speaker in the same direction in real time. The driver is therefore able to audibly track the direction of the hazard.

With reference to FIGS. 3a and 3b a further scenario is depicted. In this scenario a potential hazard in the form of a cyclist 304 approaching the rear of the vehicle is shown. The sensors 112 and/or wireless receiver 114 may determine the presence of the cyclist and with data from the sensors 112 and/or receiver 114 the controller 110 may determine the nature of the potential hazard and the relative direction from the driver to the potential hazard. As depicted in FIG. 3a, the controller 110 may then select one or more speakers 320a which are in line with the directional line 322a from the driver to the cyclist 304. As shown in FIG. 3b, when the cyclist 304 passes the side of the vehicle 104, the relative direction from the driver changes and the controller 110 selects different speakers 320b, which are in line with the new directional line 322b and the warning sound is emitted from these new speakers.

As the cyclist may have little or no sound associated therewith, the warning sound may comprise a pre-determined warning sound associated with a hazard in the form of cyclists. For example, the warning sound may comprise the word “bicycle”. The driver 102 of the vehicle is therefore provided with a warning that indicates to the driver the nature of the hazard and the relative direction of the hazard.

In the particular example shown in FIG. 3, the hazard may be in a blind spot of the driver and would not have otherwise been visible. Furthermore as the cyclist passes the vehicle, the driver is provided with information that indicates the relative position of the cyclist from the vehicle 104 without the driver having to avert her gaze.

In addition to emitting the warning sound, the controller 110 may attenuate other sounds within the vehicle. For example, any audio systems playing media content may have their volume turned down or off. Such attenuation may help to heighten the driver's awareness of the warning sound.

The controller 110 may additionally determine the distance of the hazard from the vehicle, e.g. using data from the wireless receiver 114 and/or sensors 112. The warning sound may convey information that indicates the distance from the vehicle 104 to the hazard. For example, the warning sound may comprise words that provide such distance information, e.g. “hazard at five meters”. Additionally or alternatively, the frequency and/or volume of a warning sound may vary with the distance of the hazard from the vehicle. For example, the warning sound may get louder as the hazard gets closer to the vehicle or the warning sound may get quieter as the hazard gets further away from the vehicle.

The controller 110 may also be configured to determine the relative velocity between the hazard and the vehicle 104, e.g. using data from the wireless receiver 114 and/or sensors 112. The frequency of the warning sound may vary according to the relative velocity between the hazard and the vehicle 104. In this way, the Doppler effect may be simulated. For example, as the vehicle 104 passes a hazard the frequency of the warning sound may change in a manner similar to that experienced when passing an emergency response vehicle with its siren sounding. A more natural warning may thus be provided to the driver 102 of the vehicle 104.

If the directional line 222, 322 from the driver 102 to the hazard passes between neighboring speakers 120, the controller 110 may emit sound from each of the neighboring speakers. The controller 110 may emit sound from each of the speakers at equal volume. Alternatively, to provide a smoother transition between speakers as the directional line moves with the hazard, the controller may provide a warning sound with greater volume from the speaker 120 that is closest to the directional line. Thus, as the directional line moves from one speaker to the next a smooth transition in volume is attained and a warning sound is provided to the driver. The driver is given the impression that the sound is not coming from a particular speaker but is instead gradually moving.

It will be appreciated by those skilled in the art that although the claimed subject matter has been described by way of example, with reference to one or more examples, it is not limited to the disclosed examples and alternative examples may be constructed without departing from the scope of the appended claims.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments not explicitly illustrated or described.

What is claimed is:

1. A method for indicating potential hazards to a driver of a vehicle having speakers spaced about a vehicle interior, comprising:
in response to detecting a hazard based on signals from one or more vehicle sensors, emitting a verbal warning sound specific to a type of the hazard with a volume varying with distance from the hazard from at least one of the speakers directionally aligned with the hazard and the driver.

2. The method of claim 1 further comprising:
amplifying a sound from the hazard; and
emitting the amplified sound from the at least one of the speakers.

3. The method of claim 2, wherein the method further comprises:
tracking movement of the hazard; and
emitting the verbal warning from a different one of the speakers in response to a change in directional alignment of the hazard relative to the driver and the at least one of the speakers.

4. The method of claim 1 wherein emitting comprises emitting the verbal warning from a pair of neighboring speakers if the hazard is directionally aligned between the neighboring speakers.

5. The method of claim 4, wherein the method further comprises emitting the verbal warning at a higher volume from a first speaker of the pair of neighboring speakers relative to a second speaker of the pair of neighboring speakers in response to the hazard being directionally aligned closer to the first speaker than the second speaker.

6. The method of claim 1 further comprising attenuating audio sounds from the speakers not associated with the hazard.

7. The method of claim 1 further comprising increasing the volume of the verbal warning as the distance of the vehicle from the hazard decreases.

8. The method of claim 1 further comprising decreasing the volume of the verbal warning as the distance of the vehicle from the hazard increases.

9. The method of claim 1 further comprising:
emitting a warning sound associated with a type of hazard from the at least one of the speakers in addition to the verbal warning; and
changing frequency of the warning sound based on relative velocity between the hazard and the vehicle.

10. The method of claim 1 further comprising:
emitting a warning sound associated with a type of hazard from the at least one of the speakers in addition to the verbal warning; and
wherein the warning sound has a higher frequency as the hazard approaches the vehicle and a lower frequency as the hazard moves away from the vehicle to simulate a Doppler effect.

11. The method of claim 1 further comprising communicating with another vehicle to determine presence or position of the hazard.

12. The method of claim 1 further comprising communicating, by the vehicle, with a server to determine presence or position of the hazard.

13. A vehicle comprising:
sensors configured to detect position and distance of a hazard relative to a vehicle driver position;
speakers disposed within a vehicle interior; and
a controller programmed to, in response to the sensors detecting the hazard, generate a verbal warning from at least one of the speakers selected based on the position of the hazard relative to the vehicle driver position with a volume based on the distance.

14. The vehicle of claim 13 wherein the verbal warning is specific to a type of hazard.

15. The vehicle of claim 13 wherein the controller is further programmed to amplify a sound from the hazard and generate an amplified sound from the at least one of the speakers.

16. The vehicle of claim 15 wherein the controller is further programmed to vary a frequency of the amplified sound based on the distance of the hazard and whether the distance is increasing or decreasing.

17. The vehicle of claim 15 wherein the controller is further programmed to change frequency of the sound to simulate a Doppler effect based on the distance of the hazard relative of the vehicle driver position.

18. A vehicle warning system, comprising:
a controller programmed to generate a signal for at least one of a plurality of speakers within a vehicle selected based on direction and distance of a hazard detected by at least one vehicle sensor relative to a vehicle driver position, the signal having an amplitude and frequency varying in response to the distance of the hazard.

19. The vehicle warning system of claim 18 wherein the controller is further programmed to generate the signal to simulate a Doppler effect based on the distance.

20. The vehicle warning system of claim 19 wherein the controller is configured to generate a signal corresponding to one of a plurality of verbal warnings specific to a particular type of the hazard detected.
